(19) United States
(12) Patent Application Publication
(10) Pub. No.: US 2015/0123850 A1
(43) Pub. Date: May 7, 2015

(54) RADAR SENSOR ASSEMBLY FOR MACHINE

(71) Applicant: Caterpillar Inc., Peoria, IL (US)

(72) Inventors: Fazal A. Goraya, Dunlap, IL (US); Melissa A. McTavish, Peoria, IL (US); Daniel J. Frericks, Chillicothe, IL (US); Todd G. Nakanishi, Brimfield, IL (US)

(73) Assignee: Caterpillar Inc., Peoria, IL (US)

(21) Appl. No.: 14/591,944

(22) Filed: Jan. 8, 2015

(51) Int. Cl. G01S 7/02; G01S 13/02

(52) U.S. Cl. CPC G01S 7/02; G01S 13/02; G01S 2007/027
USPC 342/385

(57) ABSTRACT

A radar sensor assembly that includes a radar sensor and a holder assembly is provided. The holder assembly includes a base plate, a first wall, a second wall, a third wall, and a bottom wall. Each of the first wall, the second wall, and the third wall extends from the base plate, and along with the bottom wall, define a sensor-holding portion. The first side and the second side define a sliding side to allow slidable accommodation of the radar sensor, in the sensor-holding portion. The sliding side includes a retention tab, which depresses to facilitate sliding of the radar sensor into the sensor-holding portion, and lifts to retain the radar sensor in the sensor-holding portion. At least one of the first wall, the second wall, and the third wall, includes one or more retention elements that prevent displacement of the radar sensor.

### TECHNICAL FIELD

The present disclosure generally relates to machines having on-board equipment to detect objects. More particularly, the present disclosure relates to a radar sensor assembly for a machine.

### BACKGROUND

Large machines, such as wheel loaders, off-highway haul trucks, excavators, motor graders, and other types of earth-moving machines, are used to perform a variety of tasks, that often involve moving and stopping at certain locations within a worksite. In addition, it is not uncommon for objects or obstacles, such as light duty vehicles, to move around the large machine, completely unnoticed by an operator. When the obstacle remains unnoticed, the machine may move and collide with the obstacle, which ultimately affects the productivity and efficiency at the worksite. There are known systems that include the obstacle or collision-avoidance and warning systems, such as radar (radio detection and ranging), sonar, and other detection techniques. These systems are frequently used to detect obstacles without the requirement of visual contact. The application of such detection techniques has been expanded to include use in both passive and active collision avoidance systems. In such collision-avoidance applications, a detection system is used to detect obstacles in the path of a moving mobile machine. When an obstacle is detected, appropriate steps are taken to avoid collision with the mobile machine. Such steps can include halting the mobile machine, altering the machine's path, or simply alerting an operator of the mobile machine to the threat of collision.

One challenge for collision-avoidance systems that use conventional detection systems is minimizing false alarms. Depending on the system characteristics, threshold settings, and operating environment, conventional systems may be susceptible to false alarms. For example, in an environment with a high concentration of metallic objects, such objects may appear as obstacles to the collision-avoidance system.

U.S. Pat. No. 7,126,525 discloses a radar sensing unit that may not perform optimally due to signal leakage within the assembly which may act to degrade the integrity of the radar signals communicating back to the sensor layer.

### SUMMARY OF THE INVENTION

The present disclosure is related to a radar sensor assembly for a machine. The radar sensor assembly is housed within an enclosure and the enclosure includes a transparent cover portion.

In accordance with the present disclosure, the radar sensor assembly includes a radar sensor and a holder assembly. The radar sensor includes a signal-receiving portion and a mounting portion. The holder assembly includes a base plate, a first wall, a second wall, and a third wall. Each of the first wall, the second wall, and the third wall extends from the base plate. A bottom wall is connected to the first wall, the second wall, and the third wall, to define a sensor-holding portion. The first wall is opposite to the second wall and defines a sliding side, which is configured to facilitate a slidable accommodation of the radar sensor in the sensor-holding portion. The sliding side includes a retention tab structured to depress and lift. The sliding side depresses to facilitate sliding of the radar sensor into the sensor-holding portion and lifts to retain the radar sensor in the sensor-holding portion. At least one of the first wall, the second wall, and the third wall, includes one or more retention elements structured to prevent displacement of the radar sensor towards the transparent cover portion. In this manner, the radar sensor in the sensor-holding portion is retained. The holder assembly is resiliently mountable in the enclosure and the signal-receiving portion of the radar sensor is directed to the transparent cover portion of the enclosure.

In accordance with the present disclosure, the radar sensor assembly includes a radar sensor and a holder assembly. The radar sensor includes a signal-receiving portion and a mounting portion. The holder assembly includes a base plate, a first wall, a second wall, and a third wall. Each of the first wall, the second wall, and the third wall extend from the base plate. A bottom wall is connected to the first wall, the second wall, and the third wall to define a sensor-holding portion. The first wall is opposite to the second wall and defines a sliding side, which is configured to facilitate a slidable accommodation of the radar sensor in the sensor-holding portion. The sliding side includes a retention tab structured to depress and lift. The sliding side depresses to facilitate sliding of the radar sensor into the sensor-holding portion and lifts to retain the radar sensor in the sensor-holding portion. At least one of the first wall, the second wall, and the third wall, includes one or more retention elements structured to prevent displacement of the radar sensor towards the transparent cover portion, thereby retaining the radar sensor in the sensor-holding portion. The holder assembly is resiliently mountable in the enclosure and the signal-receiving portion of the radar sensor is directed to the transparent cover portion of the enclosure. The holder assembly is composed of nylon and carbon, wherein the proportion of the carbon lies within a range of 15 percent-25 percent of the overall composition.

### BRIEF DESCRIPTION OF THE DRAWINGS

FIG. 1 is a diagrammatic view of a machine and certain surroundings, the machine including a radar sensor assembly in accordance with the concepts of the present disclosure;

FIG. 2 is a perspective view of a radar sensor assembly of FIG. 1, in accordance with the concepts of the present disclosure;

FIG. 3 is a sectional view of a section of the radar sensor assembly of FIG. 2, sectioned along line 3-3 of FIG. 2, in accordance with the concepts of the present disclosure; and

FIG. 4 is a perspective view of a holder assembly of the radar sensor assembly of FIG. 2 with a radar sensor and all other components removed to better illustrate the construct of the holder assembly, in accordance with the concepts of the present disclosure.

### DETAILED DESCRIPTION

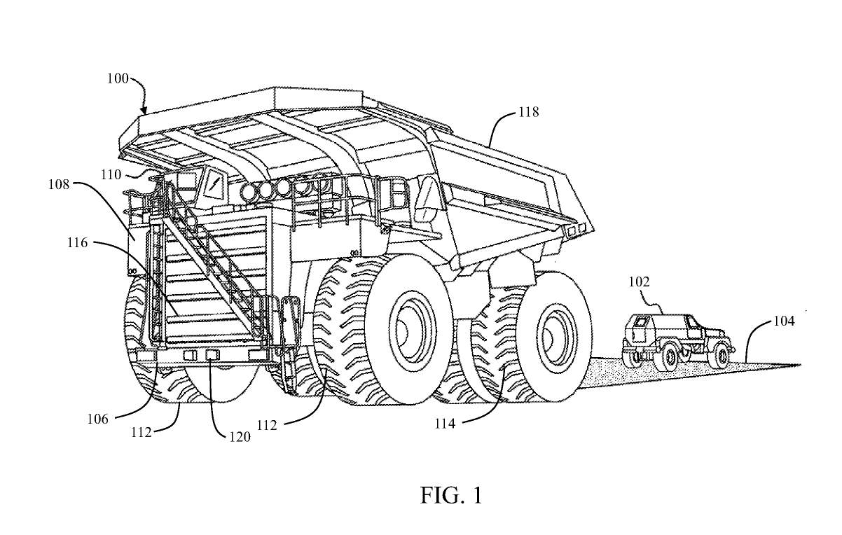

Referring to FIG. 1, there is shown a machine 100 and an obstacle 102, both located at a worksite 104. The worksite 104 may be a mine site, a landfill, a quarry, a construction site, or another type of worksite known in the art. Although the machine 100 is depicted as an off-highway haul truck, it is contemplated that the machine 100 may embody another type of large machine, such as a wheel loader, an excavator, or a motor grader. The obstacle 102 is depicted as a service vehicle. It is contemplated that the obstacle 102 may embody another type of obstacle, such as a pick-up truck or a passenger car.

The machine 100 may include a frame 106, a body 108, a cab 110, front wheel assemblies 112, rear wheel assemblies 114, a power source housing 116, a dump body 118, and a radar sensor assembly 120. The frame 106 is structured to support the body 108 of the machine 100. The cab 110 may be mounted onto the body 108, and an operator control station (not shown) may be positioned within the cab 110. The operator control station (not shown) may include a variety of operator input devices (not shown) to control and monitor operation of the machine 100. Further, the frame 106 supports axle assemblies (not shown) as is customary which in turn rotatably support the front wheel assemblies 112 and the rear wheel assemblies 114. A power source (not shown) enclosed in the power source housing 116, may be used to drive the wheel assemblies 112, 114 to propel the machine 100. The power source housing 116 is supported on the frame 106.

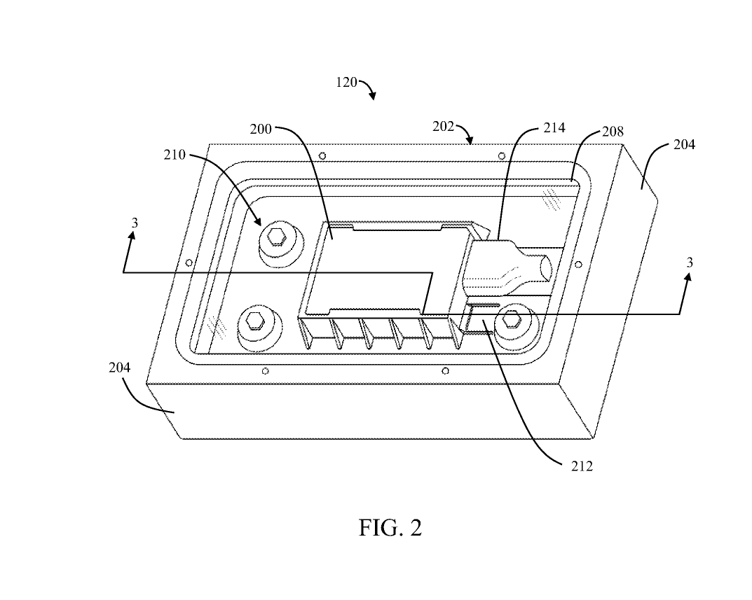

The frame 106 also supports the dump body 118, which may be tilted between a lowered position and/or a lifted position, to dump material from the dump body 118 in a conventional manner. In addition, the machine 100 also includes the radar sensor assembly 120, which may be mounted on the body 108 or the frame 106. The radar sensor assembly 120 may be mounted on a front side, a rear side, lateral sides of the machine 100, or any combination thereof. The radar sensor assembly 120 includes a radar sensor 200 (FIG. 2) therein which is configured to detect the presence of one or more obstacles in proximity of the machine 100. It will be understood that the disclosed radar sensor assembly 120 provides information to the operator relative to the environment surrounding the machine 100.

Referring to FIG. 2, the radar sensor assembly 120 includes the radar sensor 200 and an enclosure 202. The enclosure 202 may include six sides, with four metallic sidewalls 204, a bottom metallic side 206, and a transparent cover portion 208 on a top side. The radar sensor assembly 120 may include a holder assembly 210, which is adapted to hold the radar sensor 200 in place and restrict the movement thereof by use of a retention tab 212. An adapter 214 may be plugged to the radar sensor 200, as shown, to facilitate suitable connections thereof.

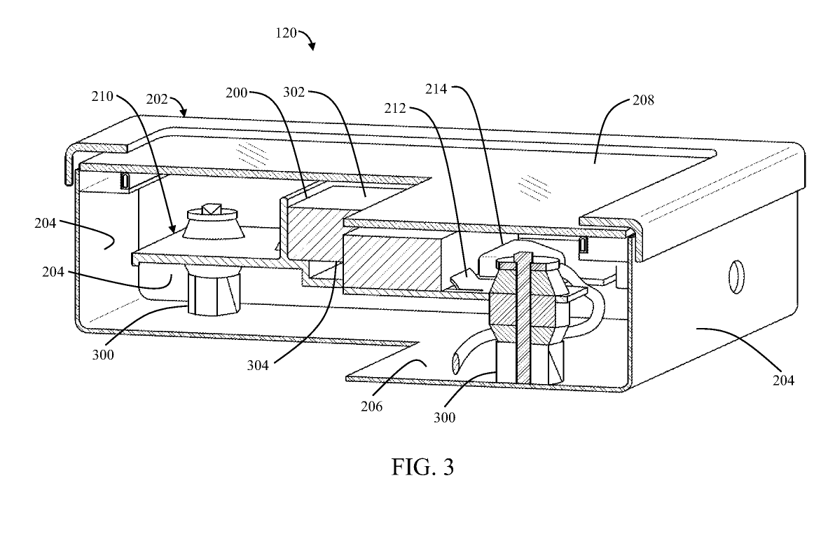

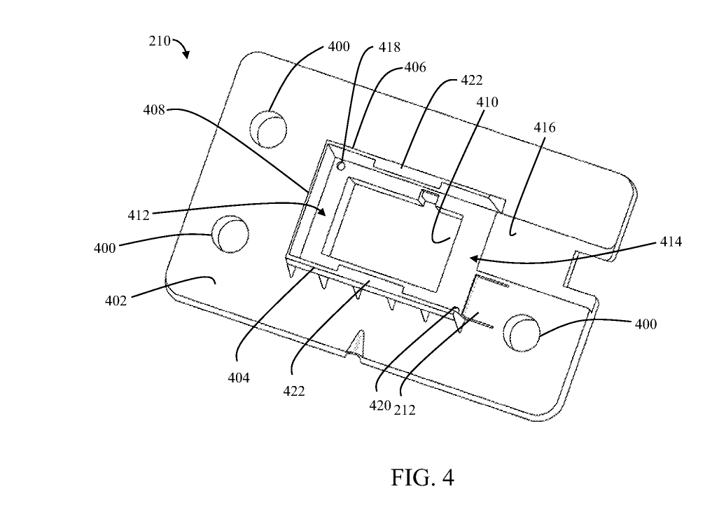

Referring to FIG. 3, there is shown a sectional view of the radar sensor assembly 120 sectioned along a line 3-3 of FIG. 2. The enclosure 202 includes three support structures 300, two of which are shown in FIG. 3, and are adapted to support the holder assembly 210. Although the embodiment illustrates the use of three support structures 300 it is envisioned that less than three would also be sufficient to properly support and restrain the holder assembly 210 in place, relative to the enclosure 202. More than three support structures 300 may also be incorporated to support and restrain the holder assembly 210. The holder assembly 210 is held by the support structures 300 in such a way that the holder assembly 210 is generally centered in the enclosure 202 and held off the bottom metallic side 206 of the enclosure 202. The holder assembly 210 is shown to accommodate the radar sensor 200. The radar sensor 200 includes a signal-receiving portion 302 and a mounting portion 304. The holder assembly 210 is resiliently mountable in the enclosure 202 in such a way, that the signal-receiving portion 302 of the radar sensor 200 is directed to the transparent cover portion 208 of the enclosure 202. The mounting portion 304 of the radar sensor 200 overlays a bottom wall 410 (FIG. 4) of the holder assembly 210.

Referring to FIG. 4, a detailed view of the holder assembly 210 is shown. The holder assembly 210 includes three slots 400, a base plate 402, a first wall 404, a second wall 406, a third wall 408, and the bottom wall 410. The slots 400 facilitate insertion of support structures 300 into the base plate 402 to position the holder assembly 210 within the enclosure 202. The first wall 404, the second wall 406, and the third wall 408, extend substantially upright from the base plate 402, towards the transparent cover portion 208. As with the base plate 402, the bottom wall 410 may be integrally structured with the first wall 404, the second wall 406, and the third wall 408, as well. The first wall 404, the second wall 406, and the third wall 408, along with the bottom wall 410, unitedly define a sensor-holding portion 412. The first wall 404 is positioned opposite to the second wall 406. Moreover, the first wall 404 and the second wall 406 together define a sliding side 414, as shown. The sliding side 414 facilitates a slidable accommodation of the radar sensor 200, across a relative elongation of the first wall 404 and the second wall 406, thereby accommodating the radar sensor 200 within the sensor-holding portion 412. The sliding side 414 is positioned opposed to the third wall 408, and includes a groove 416 to accommodate the adapter 214. Further, the sensor-holding portion 412 includes a first hole 418 and a second hole 420. The first hole 418 is proximal to a corner defined by the second wall 406 and the third wall 408. The second hole 420 is proximal to the first wall 404 and the retention tab 212. The first hole 418 and the second hole 420 facilitate insertion of push pins (not shown) in order to hold the radar sensor 200 in place.

Further, the sliding side 414 includes the retention tab 212 in relative proximity to the sensor-holding portion 412. The retention tab 212 may be a spring tab, which includes a conventional locking feature of depression and lift, to facilitate a lock. During assembly, the retention tab 212 may be first depressed, and, thereafter, the radar sensor 200 may be slid into the sensor-holding portion 412. Once the radar sensor 200 is substantially entirely accommodated, the retention tab 212 may lift to regain an original position, thereby restricting movement of the radar sensor 200 within the sensor-holding portion 412. In effect, the retention tab 212 prevents lateral slidable displacement of the radar sensor 200 from the sensor-holding portion 412. Further, the radar sensor 200 may be fastened to the holder assembly 210 by use of fir tree fasteners or other fasteners known in the art.

The holder assembly 210 may include an absorption material, which may include nylon and carbon. The amount of the carbon may be within a range of 15 percent to 25 percent of the composition. In an exemplary embodiment, the holder assembly 210 may be composed of a material, such as acrylonitrile butadiene styrene (ABS), polypropylene with glass fiber, or other thermoplastic polymers known in the art.

In addition, the holder assembly 210 includes two retention elements 422, which may be integrally attached to at least one of the first wall 404 and the second wall 406. The attachment may be at a portion that faces the transparent cover portion 208. The retention elements 422 prevent general displacement of the radar sensor 200 towards the transparent cover portion 208, or in a fore aft direction. In this manner, the radar sensor 200 is retained within the sensor-holding portion 412.

### INDUSTRIAL APPLICABILITY

In operation, the radar sensor 200 is fitted in the holder assembly 210, which is composed of the absorption material. The absorption material may be nylon and carbon. The proportion of the carbon lies within a range of 15 percent-25 percent of a composition. The holder assembly 210 absorbs the waves that may bounce around or reflect inside the enclosure 202, which thereby results in false detection of signals. The radar sensor 200 is mounted in the sensor-holding portion 412 of the holder assembly 210 in such a way that the signal-receiving portion 302 is proximal to the transparent cover portion 208 and the mounting portion 304 is proximal to the bottom wall 410 of the sensor-holding portion 412. The mounting portion 304 of the radar sensor 200 is aligned with the bottom wall 410 of the sensor-holding portion 412, such that there is no reflection of the waves, which are leaked from the mounting portion 304 and lateral sides of the radar sensor 200. This is achieved by the bottom wall 410, the first wall 404, the second wall 406, and the third wall 408, being composed of nylon and carbon, which serve as a wave absorbing medium. Hence, the waves from the lateral sides and the mounting portion 304 of the radar sensor 200 are absorbed by the holder assembly 210. In this manner, detection of false targets is inhibited. At the same time, the signal-receiving portion 302, which faces towards the transparent cover portion 208, performs the necessary transmissions that pertain to the optimum detection of targets. Further, the holder assembly 210 is equipped with the retention tab 212 and the retention elements 422, to hold the radar sensor 200 in place within the sensor-holding portion 412.

The disclosed holder assembly 210 reduces false target detection by use of wave absorbing material in the holder assembly 210. The current holder assemblies are incapable of enclosing the mounting portion 304 of the radar sensor 200. Hence, the current holder assemblies face false target detection problems. The disclosed holder assembly 210 has an advantage over the current designs, in that the disclosed holder assembly 210 provides a provision and solution to mitigate signal leakage. Hence, the facilitation of accurate target detection is accomplished. This aids in the increase of productivity and operator convenience. Also, the enclosure 202 provides a robust structure to the radar sensor assembly 120.

The many features and advantages of the disclosure are apparent from the detailed specification, and, thus, it is intended by the appended claims to cover all such features and advantages of the disclosure that fall within the true spirit and scope thereof. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A radar sensor assembly for a machine, wherein the radar sensor assembly includes an enclosure having a transparent cover portion, the radar sensor assembly comprising:
a radar sensor including a signal-receiving portion and a mounting portion; and
a holder assembly including a base plate, a first wall, a second wall, and a third wall, extending from the base plate and a bottom wall being connected to the first wall, the second wall, and the third wall to define a sensor-holding portion, the first wall being opposite to the second wall and defining a sliding side configured to facilitate a slidable accommodation of the radar sensor in the sensor-holding portion, the sliding side having a retention tab structured to depress and lift, wherein the retention tab depresses to facilitate sliding of the radar sensor into the sensor-holding portion and lifts to retain the radar sensor in the sensor-holding portion, at least one of the first wall, the second wall, and the third wall, includes one or more retention elements structured to prevent displacement of the radar sensor towards the transparent cover portion, thereby retaining the radar sensor in the sensor-holding portion, wherein the holder assembly being resiliently mountable in the enclosure and the signal-receiving portion of the radar sensor being directed to the transparent cover portion of the enclosure.

2. A radar sensor assembly for retaining a radar sensor therein, the radar sensor including a signal-receiving portion, the radar sensor assembly comprising:
a holder assembly including:
a base plate;
a first wall;
a second wall;
a third wall extending from the base plate; and
a bottom wall being connected to the first wall, the second wall and the third wall to define a sensor-holding portion, the first wall being opposite to the second wall and defining a sliding side configured to facilitate a slidable accommodation of the radar sensor in the sensor-holding portion, the sliding side having a retention tab structured to depress and lift, wherein the retention tab depresses to facilitate sliding of the radar sensor into the sensor-holding portion and lifts to retain the radar sensor in the sensor-holding portion, at least one of the first wall, the second wall, and the third wall, includes one or more retention elements structured and arranged to retain the radar sensor in the sensor-holding portion, wherein the holder assembly being composed of nylon and carbon, wherein proportion of the carbon lies within a range of 15 percent-25 percent.
